(19) United States
(12) Patent Application Publication
(10) Pub. No.: US 2023/0078103 A1
(43) Pub. Date: Mar. 16, 2023

(54) CENTRALIZED COLLECTION OF APPLICATION FILES

(71) Applicant: Citrix Systems, Inc., Fort Lauderdale, FL (US)

(72) Inventors: Ke Xu, Nanjing (CN); Zongpeng Qiao, Nanjing (CN); Ze Chen, Nanning (CN); Jie Zhuang, Nanjing (CN)

(21) Appl. No.: 17/514,294

(22) Filed: Oct. 29, 2021

Related U.S. Application Data
(63) Continuation of application No. PCT/CN2021/118119, filed on Sep. 14, 2021.

(51) Int. Cl. H04L 29/08; G06F 16/176; G06F 9/54

(52) U.S. Cl. CPC H04L 67/06; G06F 16/176; G06F 9/542; H04L 67/26

(57) ABSTRACT

According to some embodiments, a method includes: receiving, by a first computing device, a request to collect a file from a plurality of users, the request sent by a second computing device; determining, by the first computing device, a plurality of applications from which the requested file can be accessed, each of the plurality of applications used by at least one of the plurality of users; collecting, by the first computing device, files from the plurality of applications; and sending, by the first computing device to the second computing device, a link to enable a user of the second computing device to access the files collected from the plurality of applications.

### CROSS REFERENCE TO RELATED APPLICATIONS

This application is a continuation of and claims the benefit of and priority to Patent Application No. PCT/CN2021/118119 filed on Sep. 14, 2021, the contents of which is hereby incorporated herein by reference in its entirety.

### BACKGROUND

Various types of computer applications allow users to share images, documents, and other types of files with other users. For example, users can share files within collaboration applications such as TEAMS and SLACK, within social applications such as TWITTER and FACEBOOK, using dedicated file sharing applications such as SHAREFILE, DROPBOX, ONEDRIVE, etc. Within a given company or other type of organization, different users or groups of users may prefer to use different applications that provide similar functionality. For example, a development team a company may prefer to collaborate using SLACK whereas a management team at the company may prefer to use email (e.g., OUTLOOK).

### SUMMARY

It is appreciated herein that it can be difficult and/or time consuming to share files across different applications. For example, some applications require both the person sending a file and the person receiving that file to be registered users of the application and/or to have the application installed on their client devices. Even if all users within an organization use at least one application in common (e.g., email), it may be time consuming for a user to download/access a file within one application (e.g., SLACK) and then send the file using another application (e.g., compose an email that includes the file as an attachment). This may also result in increased computer storage and processing usage on client devices and/or application servers. Moreover, many organizations place limits on the size of email attachments, making difficult or impossible to share large files via email.

The present disclosure relates to systems and methods for automatically collecting application files across multiple different computer applications and providing a unified interface for accessing such collected files. Embodiments can collect images, documents, and other types of files from a variety of applications including but not limited to software-as-a-service (SaaS) applications. The techniques described herein can be used to improve the efficiency and utility of existing computer systems and applications. For example, disclosed embodiments can significantly reduce the amount of time required for a user to collect application files from one or more other users, as well as reducing the amount of storage and/or processing resources consumed in the process.

According to one aspect of the disclosure, a method can include receiving, by a first computing device, a request to collect a file from a plurality of users, the request sent by a second computing device; determining, by the first computing device, a plurality of applications from which the requested file can be accessed, each of the plurality of applications used by at least one of the plurality of users; collecting, by the first computing device, files from the plurality of applications; and sending, by the first computing device to the second computing device, a link to enable a user of the second computing device to access the files collected from the plurality of applications.

In some embodiments, the request to collect the file may include a description of the file and information identifying the plurality of users from whom to collect the file. In some embodiments, the request to collect the file further can include a sample file. In some embodiments, the determining of the plurality of applications from which the requested file can be accessed may include, for at least one user of the plurality of users: sending a notification to a computing device associated with the at least one user, the notification including a description of the file; and receiving, from the computing device associated with the at least one user, information identifying at least one application from the plurality of applications.

In some embodiments, the plurality of applications may include one or more software-as-a-service (SaaS) applications. In some embodiments, the method can include: sending, by the first computing device, the collected files to be stored within a file sharing service, wherein the link to enable the user of the second computing device to access the files includes a link to the file sharing service. In some embodiments, the sending of the collected files to be stored within the file sharing service can include sending the collected files to be stored as an archive within the file sharing service.

In some embodiments, the collecting of files from the plurality of applications may include, for at least one application of the plurality of applications, retrieving information about files uploaded to the at least one application using an application programming interface (API) of the at least application. In some embodiments, the method can include authenticating with the API of the at least application using credentials associated with a user of the second computing device.

According to another aspect of the disclosure, a system can include a processor and a non-volatile memory storing computer program code that when executed on the processor causes the processor to execute one or more described embodiments of the method. According to another aspect of the disclosure, a non-transitory computer-readable medium storing program instructions that are executable for performing one or more described embodiments of the method.

### BRIEF DESCRIPTION OF THE DRAWINGS

The manner of making and using the disclosed subject matter may be appreciated by reference to the detailed description in connection with the drawings, in which like reference numerals identify like elements.

FIG. 1 is a diagram illustrating an example network environment of computing devices in which various aspects of the disclosure may be implemented, in accordance with an embodiment of the present disclosure.

FIG. 2 is a block diagram illustrating selective components of an example computing device in which various aspects of the disclosure may be implemented, in accordance with an embodiment of the present disclosure.

FIG. 3 is a diagram of a cloud computing environment in which various aspects of the concepts described herein may be implemented.

FIG. 4A is a block diagram of an example system in which resource management services may manage and streamline access by clients to resource feeds (via one or more gateway services) and/or software-as-a-service (SaaS) applications.

FIG. 4B is a block diagram showing an example implementation of the system shown in FIG. 4A in which various resource management services as well as a gateway service are located within a cloud computing environment.

FIG. 4C is a block diagram similar to that shown in FIG. 4B but in which the available resources are represented by a single box labeled “systems of record,” and further in which several different services are included among the resource management services.

FIG. 5 is block diagram of a system for the centralized collection of application files, according to some embodiments.

FIGS. 6A and 6B are network diagrams illustrating centralized collection of files from various different applications, according to some embodiments

FIGS. 7A-7E are diagrams illustrating portions of a user interface (UI) that can be implemented within the system of FIG. 5, according to some embodiments.

FIG. 8 is an interaction diagram showing communication that can occur within the system of FIG. 5, according to some embodiments.

The drawings are not necessarily to scale, or inclusive of all elements of a system, emphasis instead generally being placed upon illustrating the concepts, structures, and techniques sought to be protected herein.

### DETAILED DESCRIPTION

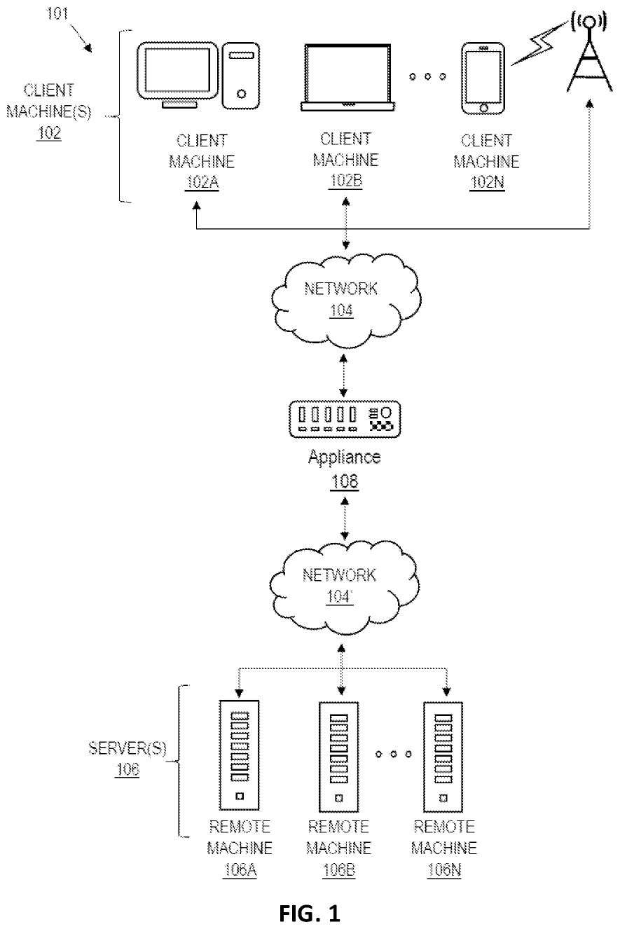

Referring now to FIG. 1, shown is an example network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

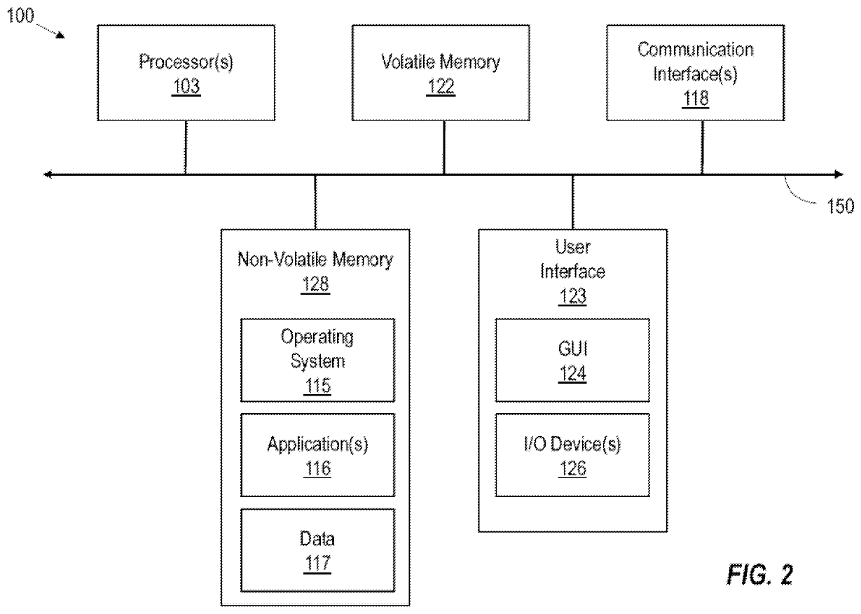

FIG. 2 is a block diagram illustrating selective components of an example computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an example client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital or mixed-signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

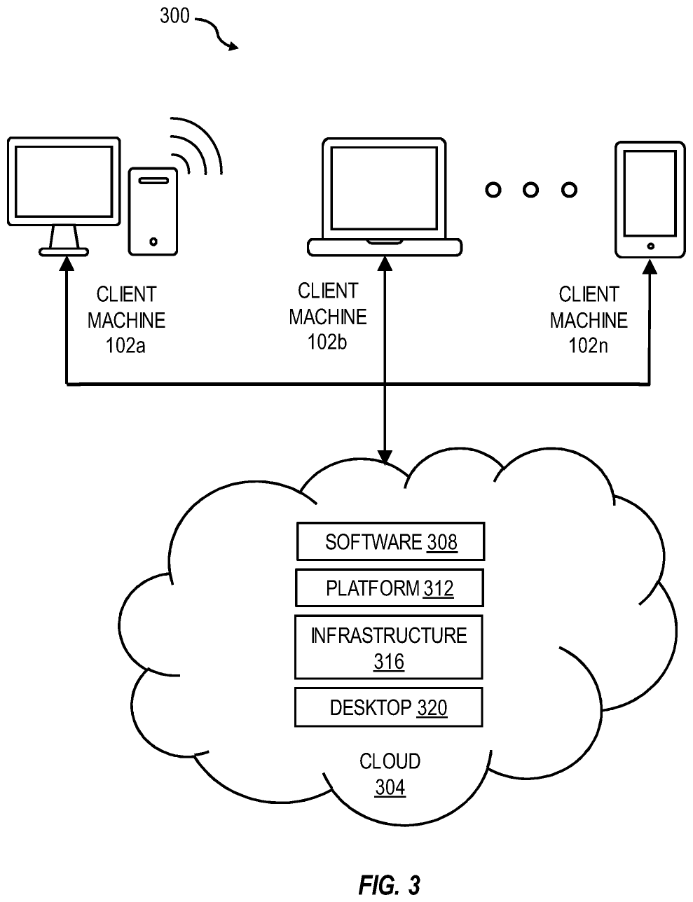

Referring to FIG. 3, a cloud computing environment 300 is depicted, which may also be referred to as a cloud environment, cloud computing or cloud network. The cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 300, one or more clients 102a-102n (such as those described above) are in communication with a cloud network 304. The cloud network 304 may include back-end platforms, e.g., servers, storage, server farms or data centers. The users or clients 102a-102n can correspond to a single organization/tenant or multiple organizations/tenants. More particularly, in one example implementation the cloud computing environment 300 may provide a private cloud serving a single organization (e.g., enterprise cloud). In another example, the cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 300 may provide a hybrid cloud that is a combination of a public cloud and a private cloud. Public clouds may include public servers that are maintained by third parties to the clients 102a-102n or the enterprise/tenant. The servers may be located off-site in remote geographical locations or otherwise.

The cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 300 can provide an elasticity to dynamically scale out or scale in response to different demands from one or more clients 102. In some embodiments, the cloud computing environment 300 can include or provide monitoring services to monitor, control and/or generate reports corresponding to the provided shared services and resources.

In some embodiments, the cloud computing environment 300 may provide cloud-based delivery of different types of cloud computing services, such as Software as a service (SaaS) 308, Platform as a Service (PaaS) 312, Infrastructure as a Service (IaaS) 316, and Desktop as a Service (DaaS) 320, for example IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

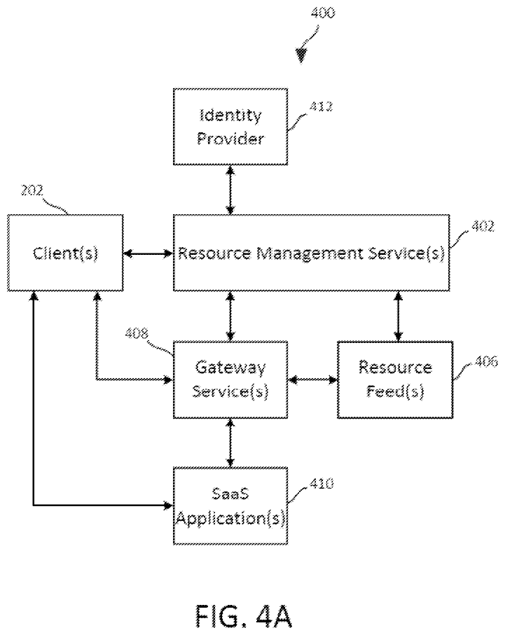

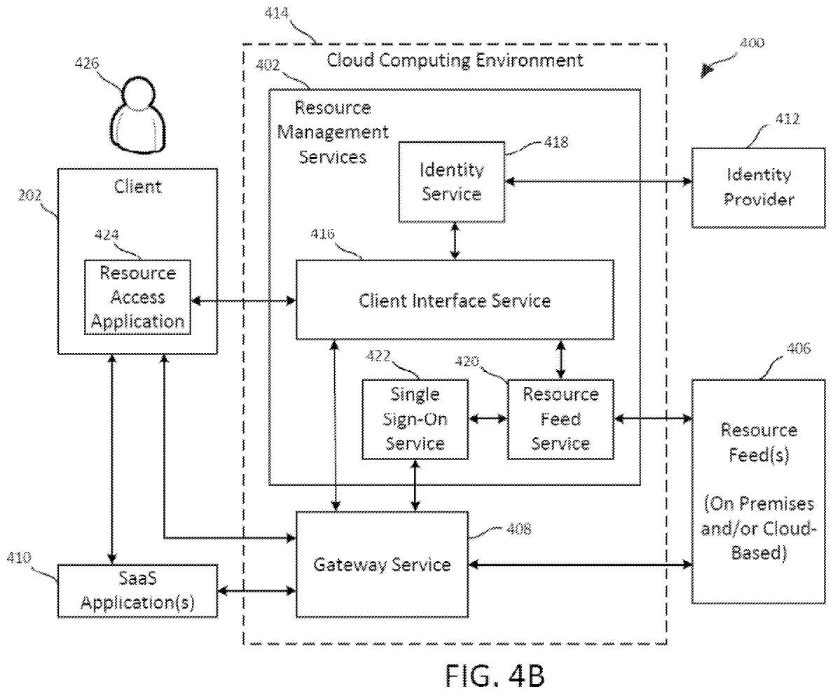

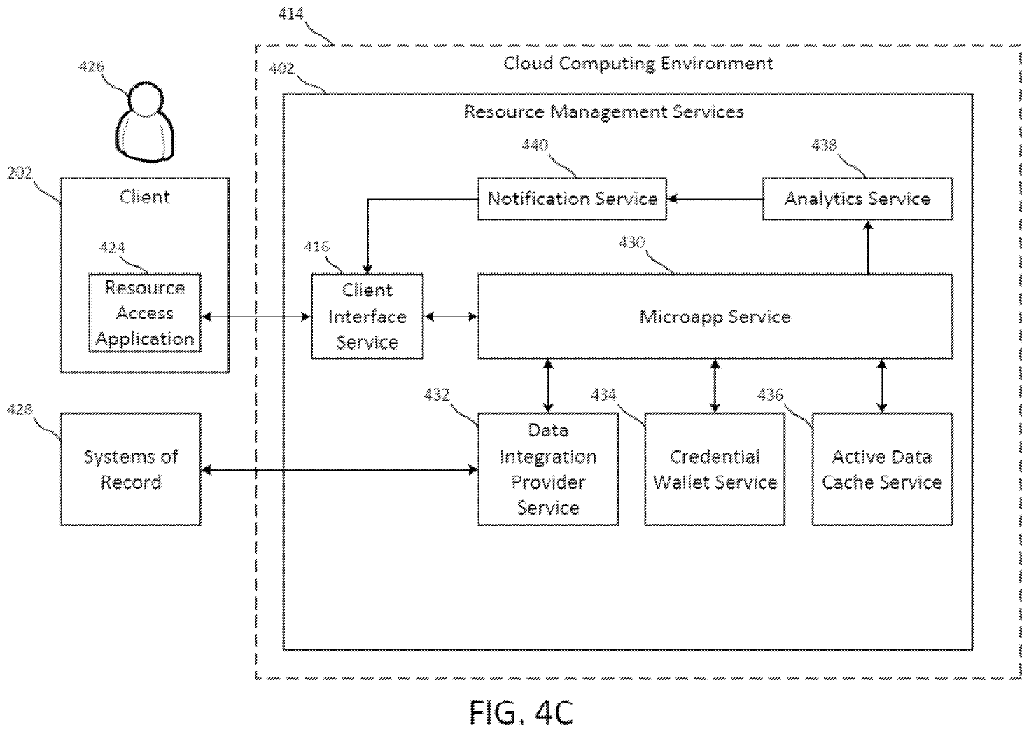

FIG. 4A is a block diagram of an example system 400 in which one or more resource management services 402 may manage and streamline access by one or more clients 202 to one or more resource feeds 406 (via one or more gateway services 408) and/or one or more software-as-a-service (SaaS) applications 410. In particular, the resource management service(s) 402 may employ an identity provider 412 to authenticate the identity of a user of a client 202 and, following authentication, identify one of more resources the user is authorized to access. In response to the user selecting one of the identified resources, the resource management service(s) 402 may send appropriate access credentials to the requesting client 202, and the client 202 may then use those credentials to access the selected resource. For the resource feed(s) 406, the client 202 may use the supplied credentials to access the selected resource via a gateway service 408. For the SaaS application(s) 410, the client 202 may use the credentials to access the selected application directly.

The client(s) 202 may be any type of computing devices capable of accessing the resource feed(s) 406 and/or the SaaS application(s) 410, and may, for example, include a variety of desktop or laptop computers, smartphones, tablets, etc. The resource feed(s) 406 may include any of numerous resource types and may be provided from any of numerous locations. In some embodiments, for example, the resource feed(s) 406 may include one or more systems or services for providing virtual applications and/or desktops to the client(s) 202, one or more file repositories and/or file sharing systems, one or more secure browser services, one or more access control services for the SaaS applications 410, one or more management services for local applications on the client(s) 202, one or more internet enabled devices or sensors, etc. Each of the resource management service(s) 402, the resource feed(s) 406, the gateway service(s) 408, the SaaS application(s) 410, and the identity provider 412 may be located within an on-premises data center of an organization for which the system 400 is deployed, within one or more cloud computing environments, or elsewhere.

FIG. 4B is a block diagram showing an example implementation of the system 400 shown in FIG. 4A in which various resource management services 402 as well as a gateway service 408 are located within a cloud computing environment 414. The cloud computing environment may, for example, include Microsoft Azure Cloud, Amazon Web Services, Google Cloud, or IBM Cloud.

For any of illustrated components (other than the client 202) that are not based within the cloud computing environment 414, cloud connectors (not shown in FIG. 4B) may be used to interface those components with the cloud computing environment 414. Such cloud connectors may, for example, run on Windows Server instances hosted in resource locations and may create a reverse proxy to route traffic between the site(s) and the cloud computing environment 414. In the illustrated example, the cloud-based resource management services 402 include a client interface service 416, an identity service 418, a resource feed service 420, and a single sign-on service 422. As shown, in some embodiments, the client 202 may use a resource access application 424 to communicate with the client interface service 416 as well as to present a user interface on the client 202 that a user 426 can operate to access the resource feed(s) 406 and/or the SaaS application(s) 410. The resource access application 424 may either be installed on the client 202, or may be executed by the client interface service 416 (or elsewhere in the system 400) and accessed using a web browser (not shown in FIG. 4B) on the client 202.

As explained in more detail below, in some embodiments, the resource access application 424 and associated components may provide the user 426 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 424 is launched or otherwise accessed by the user 426, the client interface service 416 may send a sign-on request to the identity service 418. In some embodiments, the identity provider 412 may be located on the premises of the organization for which the system 400 is deployed. The identity provider 412 may, for example, correspond to an on-premises Windows Active Directory. In such embodiments, the identity provider 412 may be connected to the cloud-based identity service 418 using a cloud connector (not shown in FIG. 4B), as described above. Upon receiving a sign-on request, the identity service 418 may cause the resource access application 424 (via the client interface service 416) to prompt the user 426 for the user's authentication credentials (e.g., user-name and password). Upon receiving the user's authentication credentials, the client interface service 416 may pass the credentials along to the identity service 418, and the identity service 418 may, in turn, forward them to the identity provider 412 for authentication, for example, by comparing them against an Active Directory domain. Once the identity service 418 receives confirmation from the identity provider 412 that the user's identity has been properly authenticated, the client interface service 416 may send a request to the resource feed service 420 for a list of subscribed resources for the user 426.

In other embodiments (not illustrated in FIG. 4B), the identity provider 412 may be a cloud-based identity service, such as a Microsoft Azure Active Directory. In such embodiments, upon receiving a sign-on request from the client interface service 416, the identity service 418 may, via the client interface service 416, cause the client 202 to be redirected to the cloud-based identity service to complete an authentication process. The cloud-based identity service may then cause the client 202 to prompt the user 426 to enter the user's authentication credentials. Upon determining the user's identity has been properly authenticated, the cloud-based identity service may send a message to the resource access application 424 indicating the authentication attempt was successful, and the resource access application 424 may then inform the client interface service 416 of the successfully authentication. Once the identity service 418 receives confirmation from the client interface service 416 that the user's identity has been properly authenticated, the client interface service 416 may send a request to the resource feed service 420 for a list of subscribed resources for the user 426.

For each configured resource feed, the resource feed service 420 may request an identity token from the single sign-on service 422. The resource feed service 420 may then pass the feed-specific identity tokens it receives to the points of authentication for the respective resource feeds 406. Each resource feed 406 may then respond with a list of resources configured for the respective identity. The resource feed service 420 may then aggregate all items from the different feeds and forward them to the client interface service 416, which may cause the resource access application 424 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 202, and/or one or more SaaS applications 410 to which the user 426 has subscribed. The lists of local applications and the SaaS applications 410 may, for example, be supplied by resource feeds 406 for respective services that manage which such applications are to be made available to the user 426 via the resource access application 424. Examples of SaaS applications 410 that may be managed and accessed as described herein include Microsoft Office 365 applications, SAP SaaS applications, Workday applications, etc.

For resources other than local applications and the SaaS application(s) 410, upon the user 426 selecting one of the listed available resources, the resource access application 424 may cause the client interface service 416 to forward a request for the specified resource to the resource feed service 420. In response to receiving such a request, the resource feed service 420 may request an identity token for the corresponding feed from the single sign-on service 422. The resource feed service 420 may then pass the identity token received from the single sign-on service 422 to the client interface service 416 where a launch ticket for the resource may be generated and sent to the resource access application 424. Upon receiving the launch ticket, the resource access application 424 may initiate a secure session to the gateway service 408 and present the launch ticket. When the gateway service 408 is presented with the launch ticket, it may initiate a secure session to the appropriate resource feed and present the identity token to that feed to seamlessly authenticate the user 426. Once the session initializes, the client 202 may proceed to access the selected resource.

When the user 426 selects a local application, the resource access application 424 may cause the selected local application to launch on the client 202. When the user 426 selects a SaaS application 410, the resource access application 424 may cause the client interface service 416 request a one-time uniform resource locator (URL) from the gateway service 408 as well a preferred browser for use in accessing the SaaS application 410. After the gateway service 408 returns the one-time URL and identifies the preferred browser, the client interface service 416 may pass that information along to the resource access application 424. The client 202 may then launch the identified browser and initiate a connection to the gateway service 408. The gateway service 408 may then request an assertion from the single sign-on service 422. Upon receiving the assertion, the gateway service 408 may cause the identified browser on the client 202 to be redirected to the logon page for identified SaaS application 410 and present the assertion. The SaaS may then contact the gateway service 408 to validate the assertion and authenticate the user 426. Once the user has been authenticated, communication may occur directly between the identified browser and the selected SaaS application 410, thus allowing the user 426 to use the client 202 to access the selected SaaS application 410.

In some embodiments, the preferred browser identified by the gateway service 408 may be a specialized browser embedded in the resource access application 424 (when the resource application is installed on the client 202) or provided by one of the resource feeds 406 (when the resource application 424 is located remotely), e.g., via a secure browser service. In such embodiments, the SaaS applications 410 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 406) for assessment of its security risk by a web filtering service. For approved URLs, the specialized browser may be permitted to access the link. For suspicious links, however, the web filtering service may have the client interface service 416 send the link to a secure browser service, which may start a new virtual browser session with the client 202, and thus allow the user to access the potentially harmful linked content in a safe environment.

In some embodiments, in addition to or in lieu of providing the user 426 with a list of resources that are available to be accessed individually, as described above, the user 426 may instead be permitted to choose to access a streamlined feed of event notifications and/or available actions that may be taken with respect to events that are automatically detected with respect to one or more of the resources. This streamlined resource activity feed, which may be customized for each user 426, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 426 of something that requires the user's attention (e.g., approval of an expense report, new course available for registration, etc.).

FIG. 4C is a block diagram similar to that shown in FIG. 4B but in which the available resources (e.g., SaaS applications, web applications, Windows applications, Linux applications, desktops, file repositories and/or file sharing systems, and other data) are represented by a single box 428 labeled “systems of record,” and further in which several different services are included within the resource management services block 402. As explained below, the services shown in FIG. 4C may enable the provision of a streamlined resource activity feed and/or notification process for a client 202. In the example shown, in addition to the client interface service 416 discussed above, the illustrated services include a microapp service 430, a data integration provider service 432, a credential wallet service 434, an active data cache service 436, an analytics service 438, and a notification service 440. In various embodiments, the services shown in FIG. 4C may be employed either in addition to or instead of the different services shown in FIG. 4B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 424 without having to launch the native application. The system shown in FIG. 4C may, for example, aggregate relevant notifications, tasks, and insights, and thereby give the user 426 a dynamic productivity tool. In some embodiments, the resource activity feed may be intelligently populated by utilizing machine learning and artificial intelligence (AI) algorithms. Further, in some implementations, microapps may be configured within the cloud computing environment 414, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 4C, the systems of record 428 may represent the applications and/or other resources the resource management services 402 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 402, and in particular the data integration provider service 432, may, for example, support REST API, JSON, OData-JSON, and 6ML. As explained in more detail below, the data integration provider service 432 may also write back to the systems of record, for example, using OAuth2 or a service account.

In some embodiments, the microapp service 430 may be a single-tenant service responsible for creating the microapps. The microapp service 430 may send raw events, pulled from the systems of record 428, to the analytics service 438 for processing. The microapp service may, for example, periodically pull active data from the systems of record 428.

In some embodiments, the active data cache service 436 may be single-tenant and may store all configuration information and microapp data. It may, for example, utilize a per-tenant database encryption key and per-tenant database credentials.

In some embodiments, the credential wallet service 434 may store encrypted service credentials for the systems of record 428 and user OAuth2 tokens.

In some embodiments, the data integration provider service 432 may interact with the systems of record 428 to decrypt end-user credentials and write back actions to the systems of record 428 under the identity of the end-user. The write-back actions may, for example, utilize a user's actual account to ensure all actions performed are compliant with data policies of the application or other resource being interacted with.

In some embodiments, the analytics service 438 may process the raw events received from the microapps service 430 to create targeted scored notifications and send such notifications to the notification service 440.

Finally, in some embodiments, the notification service 440 may process any notifications it receives from the analytics service 438. In some implementations, the notification service 440 may store the notifications in a database to be later served in a notification feed. In other embodiments, the notification service 440 may additionally or alternatively send the notifications out immediately to the client 202 as a push notification to the user 426.

In some embodiments, a process for synchronizing with the systems of record 428 and generating notifications may operate as follows. The microapp service 430 may retrieve encrypted service account credentials for the systems of record 428 from the credential wallet service 434 and request a sync with the data integration provider service 432. The data integration provider service 432 may then decrypt the service account credentials and use those credentials to retrieve data from the systems of record 428. The data integration provider service 432 may then stream the retrieved data to the microapp service 430. The microapp service 430 may store the received systems of record data in the active data cache service 436 and also send raw events to the analytics service 438. The analytics service 438 may create targeted scored notifications and send such notifications to the notification service 440. The notification service 440 may store the notifications in a database to be later served in a notification feed and/or may send the notifications out immediately to the client 202 as a push notification to the user 426.

In some embodiments, a process for processing a user-initiated action via a microapp may operate as follows. The client 202 may receive data from the microapp service 430 (via the client interface service 416) to render information corresponding to the microapp. The microapp service 430 may receive data from the active data cache service 436 to support that rendering. The user 426 may invoke an action from the microapp, causing the resource access application 424 to send that action to the microapp service 430 (via the client interface service 416). The microapp service 430 may then retrieve from the credential wallet service 434 an encrypted Oauth2 token for the system of record for which the action is to be invoked, and may send the action to the data integration provider service 432 together with the encrypted Oath2 token. The data integration provider service 432 may then decrypt the Oath2 token and write the action to the appropriate system of record under the identity of the user 426. The data integration provider service 432 may then read back changed data from the written-to system of record and send that changed data to the microapp service 430. The microapp service 432 may then update the active data cache service 436 with the updated data and cause a message to be sent to the resource access application 424 (via the client interface service 416) notifying the user 426 that the action was successfully completed.

In some embodiments, in addition to or in lieu of the functionality described above, the resource management services 402 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 402 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 402 may, for example, parse these requests and respond because they are integrated with multiple systems on the back-end. In some embodiments, users may be able to interact with the virtual assistance through either the resource access application 424 or directly from another resource, such as Microsoft Teams. This feature may allow employees to work efficiently, stay organized, and deliver only the specific information being sought.

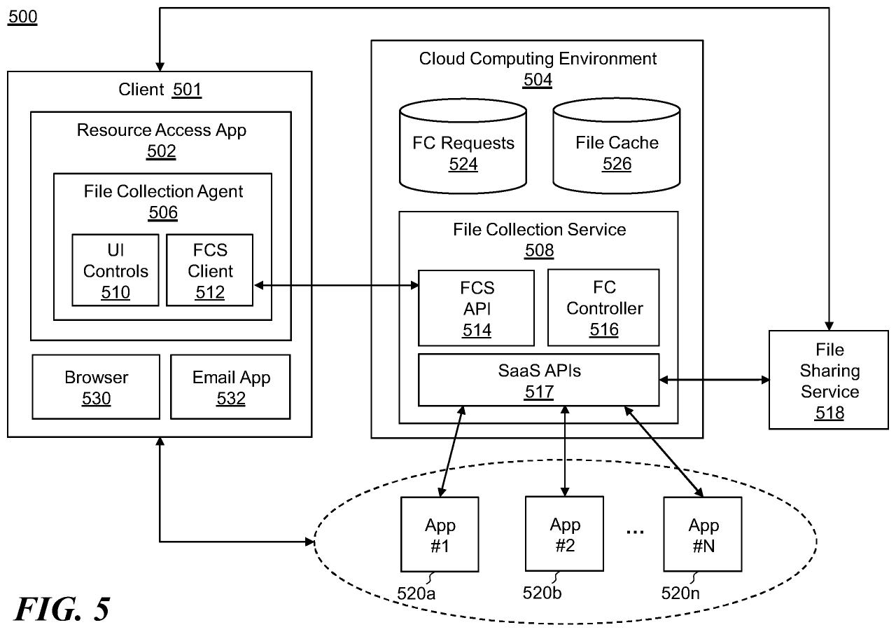

FIG. 5 shows a system for the centralized collection of application files, according to some embodiments. An illustrative system 500 includes a resource access application 502 installed on a client 501 and configured to communicate with a cloud computing environment 504. Client 501, resource access application 502, and cloud computing environment 504 of FIG. 5 can be the same as or similar to client 202, resource access application 424, and cloud computing environment 414, respectively, of FIGS. 4A-4C.

A file collection agent 506 can be provided as a sub-module or other component of resource access application 502. A file collection service 508 can be provided as a service (e.g., a microservice) within the cloud clouding environment 504. File collection agent 506 and file collection service 508 can interoperate to provide a user of client 501 to (a) request files from several other users and to collect the files from across multiple different applications in a centralized manner and/or (b) respond to such file collection requests generated by other users. To promote clarity in the drawings, FIG. 5 shows a single resource access application 502 connected to file collection service 508. However, embodiments of file collection service 508 can be used to service many resource access applications 502 used by many different users associated with one or more organizations. File collection agent 506 and/or file collection service 508 may be implemented as computer instructions executable to perform the corresponding functions disclosed herein. File collection agent 506 and file collection service 508 can be logically and/or physically organized into one or more components. In the example of FIG. 5, file collection agent 506 includes UI controls 510 and a file collection service (FCS) client 512. Also, in this example, file collection service 508 includes an FCS application programming interface (API) module 514, a file collection (FC) controller 516, and one or more SaaS application programming interface (API) modules 517.

The client-side file collection agent 506 and server-side file collection service 508 can communicate using an API. For example, file collection agent 506 can utilize FCS client 512 to send API requests (or “messages”) to file collection service 508 wherein the API requests and received and processed by API module 513. Likewise, file collection service 508 can utilize API module 513 to send API responses/messages to file collection agent 506 wherein the API responses are received and processed by FCS client 512. In some embodiments, file collection service 508 can push data to one or more clients 501. For example, file collection service 508 may send a push notification to client 501 to notify the user that a file they requested has been collected and/or to notify the user that another user is requesting a file.

In addition to resource access application 502, various other applications can be installed on client 501, such as browser 530 and email application 532. Client 501 can also provide access to one or more remote applications 520a . . . 520n (520 generally), which can include SaaS applications, for example. In some embodiments, browser 530 can be configured to access SaaS applications 520. In some embodiments, remote access application 502 can include a browser for accessing SaaS applications 520. In some embodiments, a remote application 520 can include an email server (e.g., EXCHANGE) that email application 532 (e.g., OUTLOOK) can interface with.

Referring to file collection service 508, file collection controller 516 is operable to receive file collection requests from one or more clients (e.g., via API module 514) and to process the requests using various file collection techniques disclosed herein. Briefly, file collection service 508 can receive a file collect request from a user (“requester”) of a first client 501. The file collection request can specify a list of one or more other users from whom the file is to be collected (“requestees”). File collection service 508 can determine, for each requestee, which application 520 the requestee will use (e.g., prefers to use) for sharing a version/copy of the requested file. File collection service 508 can then automatically retrieve (or “collect”) the requested file from the corresponding applications 520, send the collected files to a file sharing service 518, and provide the requester with a link (e.g., a URL) to the collected files within the file sharing service 518. In some embodiments, file sharing service 518 can correspond to SHAREFILE, DROPBOX, ONEDRIVE, or ICLOUD. In some embodiments, file collection service 408 may store files collected for multiple different requestees within file sharing service 518 as an archive (e.g., within a ZIP file).

As used herein, the term “requested file” refers to a general type/class of file specified by the parameters of a file collection request. For a given file collection request, two different requestees may provide two different files (e.g., files have different content, versions, formatting etc.) in response to the request. However, for the purpose of this disclosure, these two different files are both considered to be the same “requested file.”

Applications 520 can include various types of applications such as SaaS applications, web applications, and desktop applications. Non-limiting examples of applications 520 that can serve as data sources according the present disclosure include collaboration applications such as SLACK and TEAMS; product/project management applications such as JIRA, BASECAMP, and TRELLO; social applications such as TWITTER and FACEBOOK; and email applications such as GMAIL and OUTLOOK/EXCHANGE. In some embodiments, applications 520 can include one or more file sharing applications/services such as SHAREFILE, DROPBOX, ONEDRIVE, etc. In some embodiments, file sharing service 518 can be used to both collect requested files from requestees and to provide collected files to requesters.

Controller 516 may communicate with applications 520 and/or file sharing service 518 using SaaS API modules 517. In more detail, SaaS API modules 517 can include client-side implementations of APIs provided by applications 520 to query/retrieve files therefrom and/or can include a client-side implementation of an API provided by file sharing service 518 to send collected files thereto. For example, SaaS API modules 517 may include client-side implementations of MICROSOFT GRAPH APIs to retrieve files from EXCHANGE and/or TEAMS. As another example, SaaS API modules 517 may include client-side implementations of a SLACK API for to retrieving files from SLACK. In some embodiments, SaaS API modules 517 may include client-side implementations of one or more RESTful APIs and/or Remote Procedure Call (RPC)-based APIs.

The particular applications 520 from which controller 516 can collect information can vary between different organizations and/or between different users of the same organization. In some embodiments, controller 516 can obtain a list of services used by a particular organization and/or user. In some embodiments, controller 516 may obtain a list of subscribed resources (e.g., applications and services) for a particular user/organization via resource feed service 420 of FIG. 4B. In some cases, file collection service 508 can cause file collection agent 506 to prompt a requestees for the application that requestee will use (e.g., prefers to use) to share the requested file. Controller 516 can then use the response to this prompt to collect the requested file from a corresponding one of applications 520. In some embodiments, controller 516 can determine which application to collect the requested file for based on historical application usage information maintained for the requestee (e.g., information that indicates which application the requestee uses most often). Controller 516 may also obtain, for one or more requestees, authentication credentials (e.g., user ids and passwords, access tokens, etc.) needed to access applications 520 and/or file sharing service 518. In some embodiments, controller 516 may use a single sign-on service (e.g., service 422 of FIG. 4B) to access one or more such applications/services.

Controller 516 can utilize a database 524 to store information about pending and completed file collection requests. Database 524 may correspond, for example, to a relational database having one or more tables for storing the details of file collection requests. Database 524 may be provided as part of cloud computing environment 504, as shown in FIG. 5. For a particular file collection request, database 524 can store the request parameters (e.g., a description of the file being requested, identities of the requestees, etc.) along with state information indicating the progress/status of the file collection request (e.g., for which of the requestees the requested file has been collected from, etc.). In some embodiments, database 524 may utilize tables similar to the following FC REQUESTS TABLE and FC REQUESTEES TABLE for tracking file collection requests.

FC REQUESTS TABLE

| Column | Explanation |
|---|---|
| Id | A unique identifier for the FC request (e.g., |
| | a synthetic identifier generated by the |
| | database) |
| Requester | Name, email, or other information |
| | identifying the user that generated the FC |
| | request |
| Timestamp | Date and time when the FC request was |
| | created |
| Description | A description of the requested file |
| Sample File | Information identifying the location a |
| | sample file that was uploaded in |
| | conjunction with the FC request. May be |
| | optional. |
| Collected Files URL | URL within file sharing service 518 where |
| | the collected files can be |
| | downloaded/accessed. May be initially |
| | NULL and then subsequently |
| | generated/assigned by the file sharing |
| | service 518. |

FC REQUESTEES TABLE

| Column | Explanation |
|---|---|
| Request Id | Foreign key to FC REQUESTS TABLE |
| Requestee | Name, email, or other information |
| | identifying the requestee |
| Application | Name or other information identifying the |
| | application from which to collect the |
| | requested file for this requestee. Can be |
| | determined by prompting the requestee or |
| | automatically based on historical |
| | application usage information. Initially set |
| | to NULL, indicating the application has |
| | not yet been determined. |
| File Location | Information that can be used to locate the |
| | requested file with the application. For |
| | example, a URL to the file, a path to the |
| | file, or a search term that can be used to |
| | locate the file within the application. Can |
| | be determined by prompting the requestee |
| | or based on the request parameters. |
| | Initially set to NULL, indicating the file |
| | location has not yet been determined. |
| Collected Timestamp | The date and time the file was collected |
| | from the application for the requestee. |
| | Initially set to NULL, indicating the file |
| | has not yet been collected. |

In some embodiments, controller 516 can store collected files within a cache (e.g., file cache 526) prior to sending the collected files to file sharing service 518. In other embodiments, file cache 526 may be omitted.

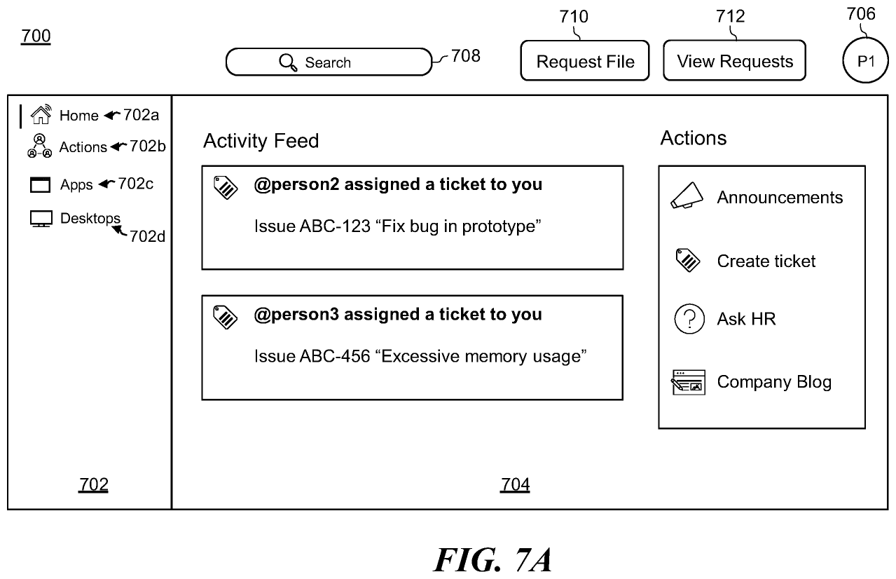

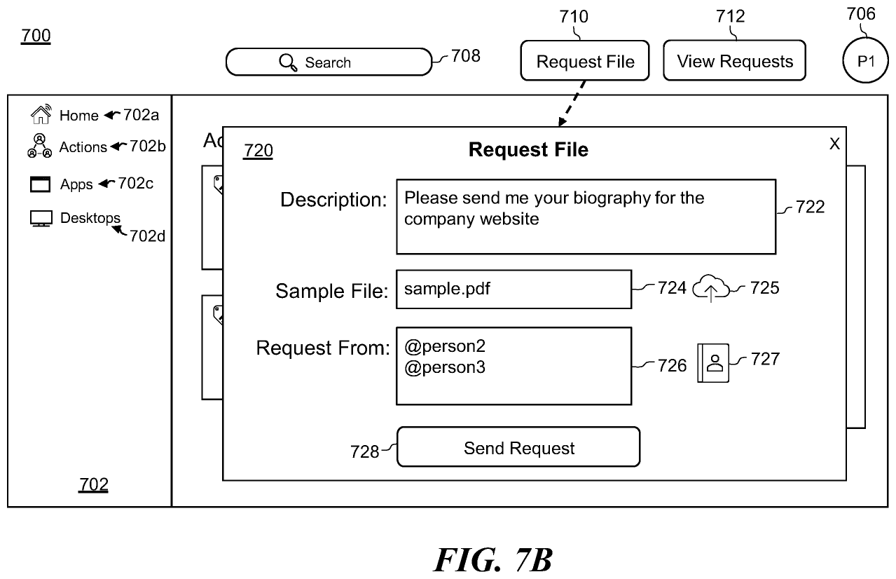

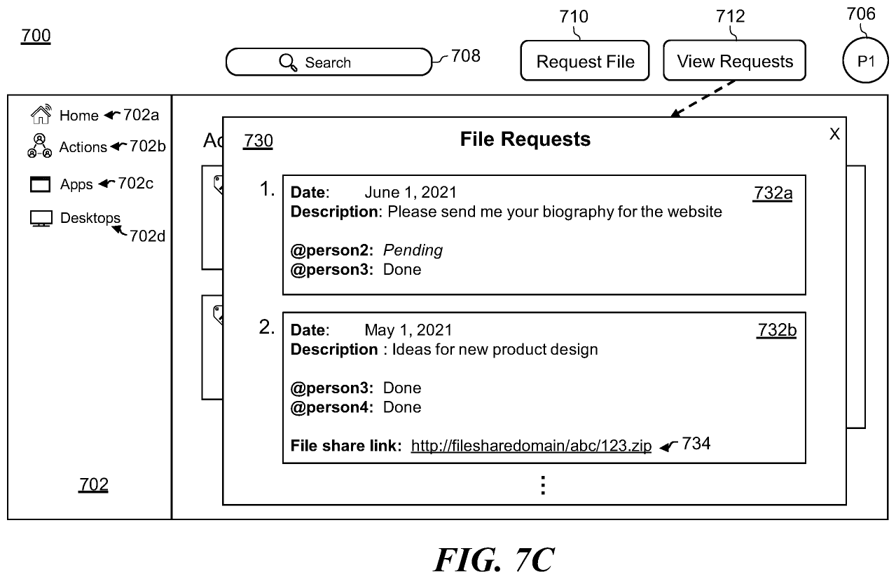

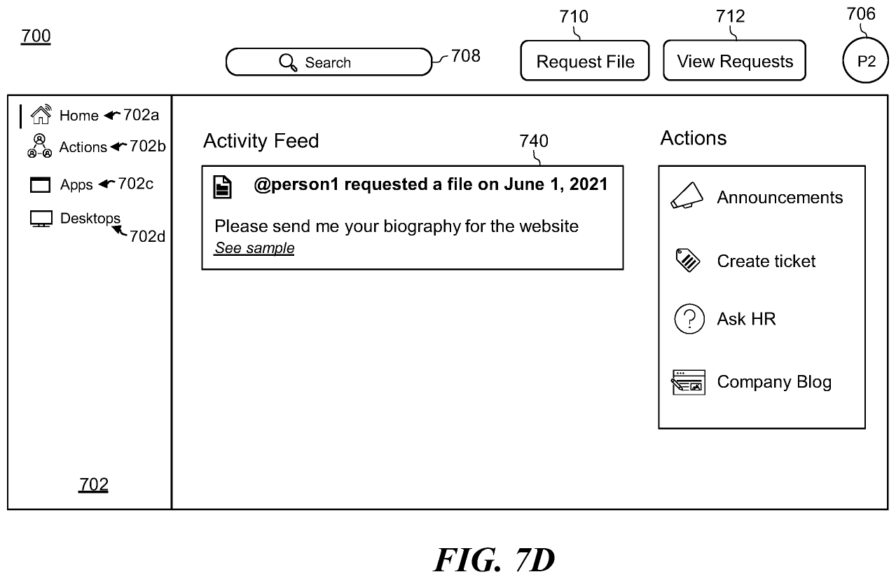

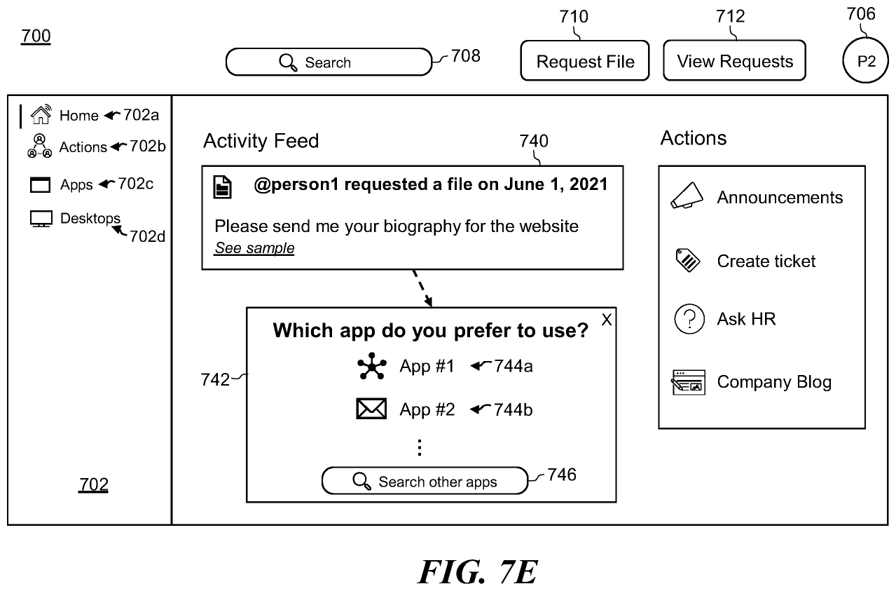

Turning to client 510, file collection agent 506 can enable a user to generate file collection requests that are sent to other users via file collection service 508 and/or enable the user to respond to file collection requests generated by other users. File collection agent 506 can also interface with file collection service 508 to enable the user to view the status of existing file collection requests and to access collected files via file sharing service 518. Examples of a UI that can be implemented within UI controls 510 to provide such functionality are described below in the context of FIGS. 7A-7E.

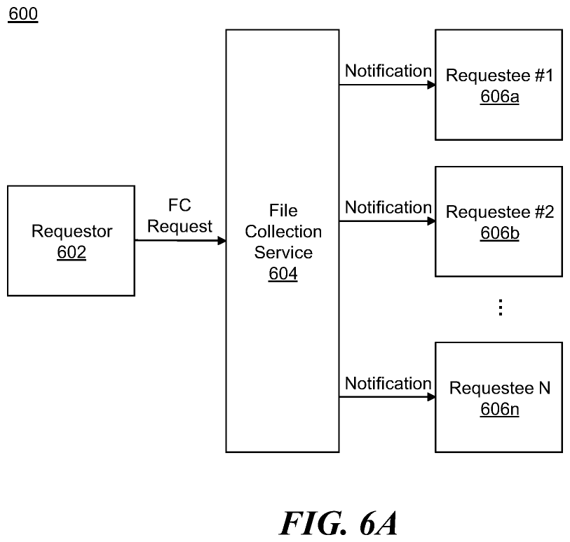

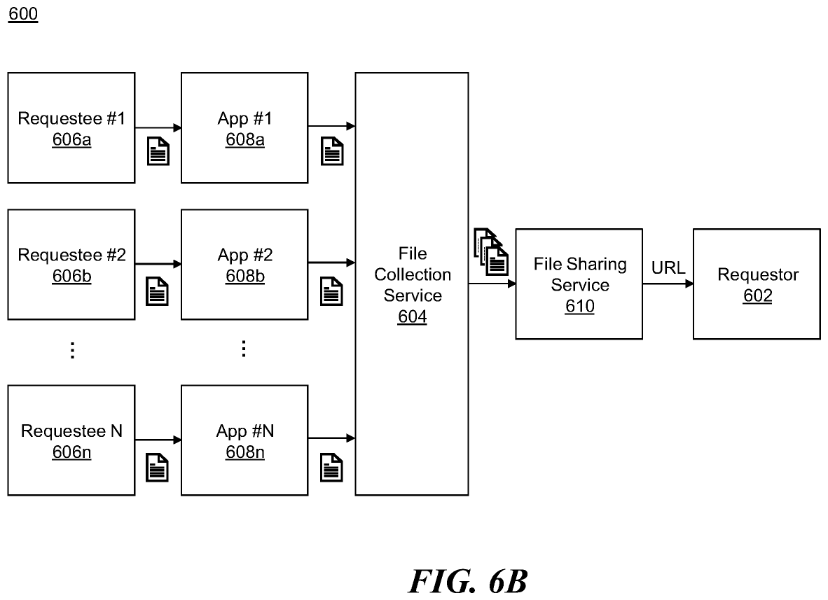

FIGS. 6A and 6B illustrate centralized collection of files from several different applications, according to some embodiments. Referring to FIG. 6A, a requester device 602 generate and send a file collection (FC) request to a file collection service 604. For example, a user of device 602 may use one or more UI controls to generate and send the file collection request. The file collection service 604 may, in turn, send corresponding request notifications to a plurality of requestee devices 606a, 606b, . . . , 606n (606 generally). Users of requestee devices 606 may be prompted to specify an application in which they have shared (or will share) the requested file.

Turning to FIG. 6B, users of requestee devices 606a, 606b, . . . , 606n may upload/share the requested file within respective applications 608a, 608b, . . . , 608n (608 generally). In turn, file collection service 604 can collect the requestee-provided files from applications 608 and send the collected files to a file sharing service 610. File collection service 610 can notify requester 602 that the collected files are available to be downloaded from/accessed within file sharing service 601. For example, file sharing service 610 may send requester 620 with a URL to access the collected files within file sharing service 610. Requester device 602 and/or requestee devices 606 may be the same as or similar to client 501 of FIG. 5. File collection service 604 may be the same as or similar to file collection service 508 of FIG. 5.

FIGS. 7A-7E illustrate portions of a UI 700 for centralized collection of application files, according to some embodiments of the present disclosure. UI 700 may be implemented, for example, within the system 500 of FIG. 5 and, more particularly, within resource access application 502 of FIG. 5. FIGS. 7A-7C illustrate portions of a UI that can be used for generating and viewing file collection requests by a first user (“person1”) whereas FIGS. 7D and 7E illustrate portions of a UI that can be used for responding to file collection requests by a second user (“person2”). That is, “person1” may correspond to a requester and “person2” may correspond to a requestee in the following examples.

Referring to FIG. 7A, the illustrative UI 700 includes a resource menu 702, a content view 704, a search box 708, an icon 706 to identify the user of the resource access application (e.g., the user currently authenticated with the resource access application). In the example of FIG. 7B, it is assumed that “person1” or “P1” is using the resource access application 706. UI 700 can also include a button (“‘Request File’ button”) 710 for generating a new file collection request and a button (“View Requests' button”) 712 for viewing information about existing file collection requests generated by the user. In the example shown, resource menu 702 can include a home menu item 702a, an actions menu item 702b, and a desktops menu item 702d. Menu items 702a-702e may also be referred to as “tabs.” A user may click/tap on menu items 702a-702e to access corresponding functionality of the resources access application.

Turning to FIG. 7B, in response to the user clicking/tapping the “Request File” button 710, UI 700 can present a form (or “request editor”) 720 for generating a file collection request. The request editor 720 may be presented, for example, within a modal window. Illustrative request editor 720 includes a description field 722 in which the user can enter a description of the file being requested, a sample file field 724 via which the user can provide a sample file for the request, and a field 726 in which the user can specify the identities of one or more requestees (i.e., other users from whom the file is to be collected). A sample file may be provided to help requestees understand the type/nature of the file being requested so that they can share more relevant files with the requester. To choose the sample file indicated by field 724, the user may click an upload button 725 which causes a file picker to be presented to the user. To enter the identifies of requestees, the user may enter the names, email addresses, handles, or other information identifying requestees within field 726. In addition, or in the alternative, the user may click/tap a button 727 to open an address book (e.g., a list of contacts provided by the resource access application) and then select requestees from within the address book UI. The user can click a button (“‘Send Request’ button”) 728 to cause the file collection request to be transmitted to the file collection service 508 for handling. Fields 722, 724, 726 may correspond to parameters of the file collection request that is transmitted to the file collection service 508 and stored within database 524. The identity of the person creating the request (e.g., “person1”) may also be included as a request parameter.

Turning to FIG. 7C, in response to the user clicking the “View Requests” button 712, UI 700 can present a view 730 that includes information about file collection requests generated by the user (e.g., the user indicated by icon 706). These can include requests that have been completed in addition to pending requests. A file collection request may be considered completed if the requested file has been collected from each of the requestees (i.e., from the preferred applications for each of the requestees) and stored within the file sharing service where the collected files can be downloaded by the requester. Otherwise the file collection request may be considered pending. In the example of FIG. 7C, view 730 shows a first file collection request 732a and a second file collection request 732b. The first request 732a is pending because the requested file has not yet been collected from one of the requestees, namely “person2.” The second request 732b is completed because the requested file has been collected from each requestee, namely “person3” and “person4,” and the collected files are available for download from the file sharing service (e.g., using URL 734).

Turning to FIG. 7D, in response to receiving the file collection request, the file collection service 508 can cause corresponding notifications to be sent to each of the corresponding requestees. For example, a file request notification 740 can be added to the activity feed of home tab 702a. The notification 740 can identify the requester (e.g., “person1),” the date and/or time of the request (e.g., “Jun. 1, 2021”), the description of the file being requested (e.g., “Please send me your biography for the website”), and a link to view the sample file associated with the request, if any (e.g., a link titled “See sample”).

Turning to FIG. 7E, in response to the user clicking/tapping on the file collection request notification 740, UI 700 may present a view 742 for choosing an application for sharing/providing the requested file. The view 742 can include a list of applications 744a, 744b, etc. (744 generally) and a search box 746. The list of applications 744 may include applications used by or otherwise associated with the user and/or the user's organization. In some embodiments, the list of applications 744 can correspond to a list or set of applications that the user has chosen for use within a resource access application 502. The list of applications 744 can be sorted by one or more criteria— such as how frequently or how recently the applications have been used—and the top N applications can be displayed within the list 744. The user can use search box 746 to search for applications not included within the list of applications 744. After the user has chosen an application for sharing/providing the requested file, UI 800 may cause a message to be sent to the file sharing service which, in turn, can retrieve the requested file from the chosen application.

In some embodiments, when the user selects an application, resource access application 502 can automatically launch the application and/or redirect the user to a feature of the application for uploading/sharing the requested file. For example, in the case of a SaaS application, resource access application 502 may launch a web browser and load an upload/share URL associated with the application. In some cases the resource access application 502 may automatically log the user into the application (e.g., using SSO) to further facilitate uploading/sharing of the file. In response to the user uploading/sharing the requested file, UI 800 may cause a message to be sent to the file sharing service, as previously mentioned. Various techniques can be used to detect that the user has uploaded/shared the requested file. For example, in some embodiments, UI 800 may heuristically determine that the user has uploaded/shared the file in response to the user closing the selected application (e.g., UI 800 can listen for an event associated with the closing of the application). As another example, UI 800 may include a button (e.g., a button labeled “Done”) for the user to click/tap after the requested file has been uploaded/shared within the selected application. As another example, UI 800 may receive a confirmation from the application that the upload/sharing was successful.

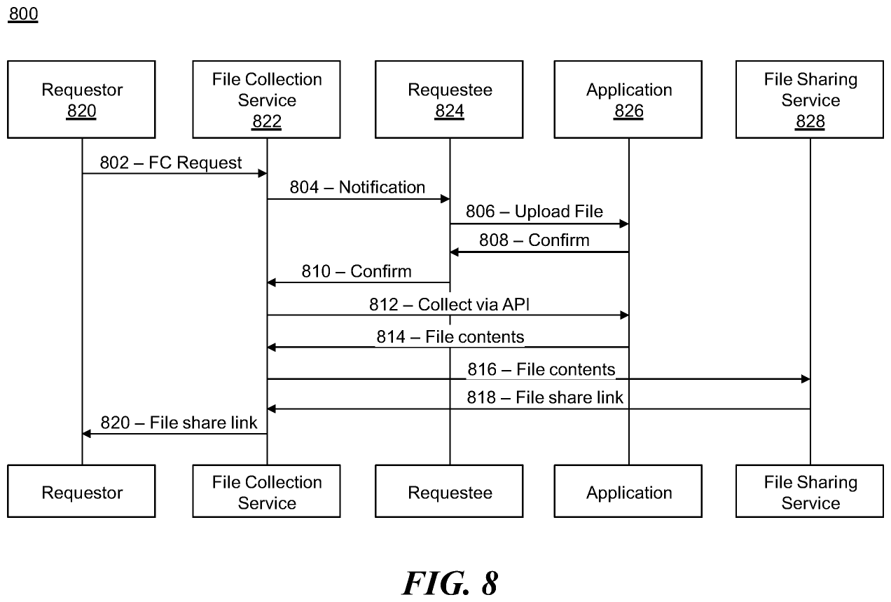

FIG. 8 illustrates communication that can occur within the system of FIG. 5, according to some embodiments. At line 802, a requestor device 820 can generate and send a file collection request to file collection service 822 (e.g., using request editor 720 of FIG. 7B). At line 804, file collection service 822 can send a corresponding notification to a requestee device 824 (or, more generally, to one or more a requestees). A user of requestee device 824 (or “requestee”) can choose application 826 for sharing the requested file (e.g., using view 742 of FIG. 7E).

At line 806, the requestee can upload the requested file from requestee device 824 to the chosen application 826 and, at line 808, the application 826 can provide a confirmation that the upload was successful. In some cases, the requestee may share the requested file with the requestor via the chosen application 826. At line 810, requestee device 824 can return a corresponding confirmation message to file collection service 822.

At line 812, file collection service 822 can collect the file from application 826 using an API provided thereby. In some embodiments, file collection service 822 can authenticate with application 826 using the requestee's credentials and can then use an API provided by application 826 to retrieve information about files uploaded by the requestee within the application 826. In some embodiments, file collection service 822 can authenticate with application 826 using the requestor's credentials and can then use an API provided by application 826 to retrieve information about files shared with the requestor via the application 826. In some embodiments, file collection service 822 can use the API to request files that have been recently uploaded by the requestee and/or shared with the requestor, for example files uploaded/shared within the past N hours or days. File collection service 822 can compare the file information returned by the API to determine which of those files, if any, corresponds to the requested file. For example, file collection service 822 may compare the name, description, or other metadata returned by the API for a file to the description of the requested file provided by the requestor. As another example, file collection service 822 may compare the contents of a file returned by the API to a sample file uploaded by the requestor.

At line 814, application 826 can return the contents of the file to file collection service 822 and, at line 816, file collection service 822 can transmit the contents of the file for storage within a file sharing service 828. More generally, file collection service 822 can collect one or more versions/copies of the requested file from one or more applications 826 and send the collected files to file collection service 822.

At line 818, the file sharing service 828 can return a URL or other type of link that can be used to access the file within file sharing service 828 which in turn can provide the URL/link to the requestor 820 at line 820.

The following examples pertain to further embodiments, from which numerous permutations and configurations will be apparent.

Example 1 includes a method including: receiving, by a first computing device, a request to collect a file from a plurality of users, the request sent by a second computing device; determining, by the first computing device, a plurality of applications from which the requested file can be accessed, each of the plurality of applications used by at least one of the plurality of users; collecting, by the first computing device, files from the plurality of applications; and sending, by the first computing device to the second computing device, a link to enable a user of the second computing device to access the files collected from the plurality of applications.

Example 2 includes the subject matter of Example 1, wherein the request to collect the file includes a description of the file and information identifying the plurality of users from whom to collect the file.

Example 3 includes the subject matter of Example 2, wherein the request to collect the file further includes a sample file.

Example 4 includes the subject matter of Example 1, wherein the determining of the plurality of applications from which the requested file can be accessed includes, for at least one user of the plurality of users: sending a notification to a computing device associated with the at least one user, the notification including a description of the file; and receiving, from the computing device associated with the at least one user, information identifying at least one application from the plurality of applications.

Example 5 includes the subject matter of Example 1, wherein the plurality of applications includes one or more software-as-a-service (SaaS) applications.

Example 6 includes the subject matter of Example 1 and further includes: sending, by the first computing device, the collected files to be stored within a file sharing service, wherein the link to enable the user of the second computing device to access the files includes a link to the file sharing service.

Example 7 includes the subject matter of Example 6, wherein the sending of the collected files to be stored within the file sharing service includes sending the collected files to be stored as an archive within the file sharing service.

Example 8 includes the subject matter of Example 1, wherein the collecting of files from the plurality of applications includes, for at least one application of the plurality of applications, retrieving information about files uploaded to the at least one application using an application programming interface (API) of the at least application.

Example 9 includes the subject matter of Example 8 and further includes authenticating with the API of the at least application using credentials associated with a user of the second computing device.

Example 10 includes a system including a processor and a non-volatile memory storing computer program code that when executed on the processor causes the processor to execute a process operable for: receiving, by a first computing device, a request to collect a file from a plurality of users, the request sent by a second computing device; determining, by the first computing device, a plurality of applications from which the requested file can be accessed, each of the plurality of applications used by at least one of the plurality of users; collecting, by the first computing device, files from the plurality of applications; and sending, by the first computing device to the second computing device, a link to enable a user of the second computing device to access the files collected from the plurality of applications.

Example 11 includes the subject matter of Example 10, wherein the request to collect the file includes a description of the file and information identifying the plurality of users from whom to collect the file.

Example 12 includes the subject matter of Example 11, wherein the request to collect the file further includes a sample file.

Example 13 includes the subject matter of Example 10, wherein the determining of the plurality of applications from which the requested file can be accessed includes, for at least one user of the plurality of users: sending a notification to a computing device associated with the at least one user, the notification including a description of the file; and receiving, from the computing device associated with the at least one user, information identifying at least one application from the plurality of applications.

Example 14 includes the subject matter of Example 10, wherein the plurality of applications includes one or more software-as-a-service (SaaS) applications.

Example 15 includes the subject matter of Example 10, the process further operable for: send, by the first computing device, the collected files to be stored within a file sharing service, wherein the link to enable the user of the second computing device to access the files includes a link to the file sharing service.

Example 16 includes the subject matter of Example 15, wherein the sending of the collected files to be stored within the file sharing service includes sending the collected files to be stored as an archive within the file sharing service.

Example 17 includes the subject matter of Example 10, wherein the collecting of files from the plurality of applications includes, for at least one application of the plurality of applications, retrieving information about files uploaded to the at least one application using an application programming interface (API) of the at least application.

Example 18 includes the subject matter of Example 17, wherein the process is further operable for authenticating with the API of the at least application using credentials associated with a user of the second computing device.

Example 19 includes a non-transitory computer readable medium storing program instructions that are executable for: receiving, by a first computing device, a request to collect a file from a plurality of users, the request sent by a second computing device; determining, by the first computing device, a plurality of applications from which the requested file can be accessed, each of the plurality of applications used by at least one of the plurality of users; collecting, by the first computing device, files from the plurality of applications; and sending, by the first computing device to the second computing device, a link to enable a user of the second computing device to access the files collected from the plurality of applications.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or another unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of nonvolatile memory, including by ways of example semiconductor memory devices, such as EPROM, EEPROM, flash memory device, or magnetic disks. The processor and the memory can be supplemented by, or incorporated in, special purpose logic circuitry.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the specification to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the following description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

All publications and references cited herein are expressly incorporated herein by reference in their entirety.

1. A method comprising:
receiving, by a first computing device, a request to collect a file from a plurality of users, the request sent by a second computing device;
determining, by the first computing device, a plurality of applications from which the requested file can be accessed, each of the plurality of applications used by at least one of the plurality of users;
collecting, by the first computing device, files from the plurality of applications; and
sending, by the first computing device to the second computing device, a link to enable a user of the second computing device to access the files collected from the plurality of applications.

2. The method of claim 1, wherein the request to collect the file includes a description of the file and information identifying the plurality of users from whom to collect the file.

3. The method of claim 2, wherein the request to collect the file further includes a sample file.

4. The method of claim 1, wherein the determining of the plurality of applications from which the requested file can be accessed includes, for at least one user of the plurality of users:
sending a notification to a computing device associated with the at least one user, the notification including a description of the file; and
receiving, from the computing device associated with the at least one user, information identifying at least one application from the plurality of applications.

5. The method of claim 1, wherein the plurality of applications includes one or more software-as-a-service (SaaS) applications.

6. The method of claim 1, further comprising:
sending, by the first computing device, the collected files to be stored within a file sharing service, wherein the link to enable the user of the second computing device to access the files includes a link to the file sharing service.

7. The method of claim 6, wherein the sending of the collected files to be stored within the file sharing service includes sending the collected files to be stored as an archive within the file sharing service.

8. The method of claim 1, wherein the collecting of files from the plurality of applications includes, for at least one application of the plurality of applications, retrieving information about files uploaded to the at least one application using an application programming interface (API) of the at least application.

9. The method of claim 8, further comprising authenticating with the API of the at least application using credentials associated with a user of the second computing device.

10. A system comprising:
a processor; and
a non-volatile memory storing computer program code that when executed on the processor causes the processor to execute a process operable for:
receiving, by a first computing device, a request to collect a file from a plurality of users, the request sent by a second computing device;
determining, by the first computing device, a plurality of applications from which the requested file can be accessed, each of the plurality of applications used by at least one of the plurality of users;
collecting, by the first computing device, files from the plurality of applications; and
sending, by the first computing device to the second computing device, a link to enable a user of the second computing device to access the files collected from the plurality of applications.

11. The system of claim 10, wherein the request to collect the file includes a description of the file and information identifying the plurality of users from whom to collect the file.

12. The system of claim 11, wherein the request to collect the file further includes a sample file.

13. The system of claim 10, wherein the determining of the plurality of applications from which the requested file can be accessed includes, for at least one user of the plurality of users:
sending a notification to a computing device associated with the at least one user, the notification including a description of the file; and
receiving, from the computing device associated with the at least one user, information identifying at least one application from the plurality of applications.

14. The system of claim 10, wherein the plurality of applications includes one or more software-as-a-service (SaaS) applications.

15. The system of claim 10, the process further operable for:
send, by the first computing device, the collected files to be stored within a file sharing service, wherein the link to enable the user of the second computing device to access the files includes a link to the file sharing service.

16. The system of claim 15, wherein the sending of the collected files to be stored within the file sharing service includes sending the collected files to be stored as an archive within the file sharing service.

17. The system of claim 10, wherein the collecting of files from the plurality of applications includes, for at least one application of the plurality of applications, retrieving information about files uploaded to the at least one application using an application programming interface (API) of the at least application.

18. The system of claim 17, wherein the process is further operable for authenticating with the API of the at least application using credentials associated with a user of the second computing device.

19. A non-transitory computer-readable medium storing program instructions that are executable for:
receiving, by a first computing device, a request to collect a file from a plurality of users, the request sent by a second computing device;
determining, by the first computing device, a plurality of applications from which the requested file can be accessed, each of the plurality of applications used by at least one of the plurality of users;
collecting, by the first computing device, files from the plurality of applications; and
sending, by the first computing device to the second computing device, a link to enable a user of the second computing device to access the files collected from the plurality of applications.
